(19) United States
(12) Patent Application Publication
(10) Pub. No.: US 2025/0193643 A1
(43) Pub. Date: Jun. 12, 2025

(54) SYSTEMS AND METHODS FOR ENABLING LOCAL SENSING AS A SERVICE IN MOBILE NETWORKS

(71) Applicant: HUAWEI TECHNOLOGIES CO., LTD., SHENZHEN (CN)

(72) Inventors: Hesham Gamal Aly Mohamed MOUSSA, Kanata (CA); Mehdi Arashmid AKHAVAIN MOHAMMADI, Kanata (CA)

(73) Assignee: HUAWEI TECHNOLOGIES CO., LTD., SHENZHEN (CN)

(21) Appl. No.: 19/055,776

(22) Filed: Feb. 18, 2025

Related U.S. Application Data
(63) Continuation of application No. PCT/CN2022/121418, filed on Sep. 26, 2022.

(51) Int. Cl. H04W 4/38; H04W 4/12; H04W 60/04

(52) U.S. Cl. CPC H04W 4/38; H04W 4/12; H04W 60/04

(57) ABSTRACT

Sensing as a service is a new paradigm that researchers have recently started to explore as another way of bringing value to the consumer of cellular services as well as to the operators of the networks. A variety of potential applications will be enabled by this paradigm shift including local sensing services such as localization, tracking, V2X applications, environmental monitoring, etc. In addition to methods, the current invention discloses a new network entity/network function, a sensing manager SM. The SM handles the sensing functionality of the network node gNB as well as the attached (registered) external sensors. The functions carried out by this new network entity are not currently supported by any available network entity in the nowadays networks.

### CROSS-REFERENCE TO RELATED APPLICATION

This application is a continuation of International Patent Application No. PCT/CN2022/121418, filed Sep. 26, 2022, entitled “SYSTEMS AND METHODS FOR ENABLING LOCAL SENSING AS A SERVICE IN MOBILE NETWORKS,” the contents of which are incorporated herein by reference in its entirety.

### TECHNICAL FIELD

The invention relates to communication networks, and more particularly to a method and an apparatus for sensing and communicating in the communication networks.

### BACKGROUND

During the last decade, sensors have become an important part of modern living. Innovative sensor solutions and sensor networks significantly enhanced our day-to-day life. Some sensor networks are in the form of private Internet of Things (IoT) networks; many of these networks are already commercially available, other sensor networks are at the development stage including the 3^{rd} Generation Partnership Project (3GPP) discussions of massive machine type communication (mMTC).

Integrated sensing and communication (ISAC), a recently introduced technology that relies on RF sensing, is envisioned to transform networks into overreaching sensing networks that could be suitable for an array of applications including: tracking and localization, smart home and in-cabin sensing, vehicle-to-everything connectivity, smart manufacturing and industrial IoT, remote sensing, and environmental monitoring. Being ubiquitous, such sensing and communication networks are seen as a great opportunity to further advance our day-to-day experience.

RF sensing has its limits versus the envisioned applications. As such, to unleash the potential of a sensing network, besides the ISAC, it is anticipated that future networks will be also integrated with other forms of sensing applications such as IoT sensors owned by operators, sensing nodes that sell their data to the operators, and joint communication and radar functionality of future networks. Combined together, the different forms of sensing will constitute a powerful sensing network capable to offer valuable services/products to an array of customers ranging from large corporations to small businesses (security companies, hospitals, nursing homes), and even to individual consumers.

Recent publications had extensively explored ISAC as a joint operation that enables integration of both communication and radar-like functionalities that co-exist on the same waveform. The ISAC is mainly looked at from the physical layer point of view to develop necessary technologies to enable the communication and radar-like functionalities. Many publications have also addressed the fundamental limits of the technology and envisioned all sorts of possible applications that can be enabled.

Ongoing R&D projects are mainly focused on device and system level development of sensing technologies, enabling their energy efficient and accurate operation, and on envisioning various end-user applications for these technologies. However, a method by which a network operator can provide sensing as a service for monetization purposes is just assumed to be there without clear definition of the process. The way a consumer of sensing services would place a sensing service request and how the serving network node gNB would handle such request is missing from the literature. There is no proper guidance on this account in the published telecom standards.

Therefore, there is a need for a method and system for enabling sensing as a service, that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of the present disclosure is to provide a method, an apparatus, and a system for enabling sensing operations. Embodiments address the task of receiving and fulfilling a request for sensing service from a UE. This can include differentiating between a communication service request and a sensing service request. This can also include interpreting and fulfilling, by the network, the sensing service request. As used herein, a sensing service request can also be referred to as a request of a networked sensing service.

According to embodiments, a provided method describes the interaction between a user equipment and the network node providing network access. The user equipment (which may be for example a mobile device, a phone, a tablet, a PC, a smart car, a TV, etc) is network enabled. A network node providing network access is often referred to herein, for simplicity, as a gNB, although other types of network nodes are possible. Also specified are the messaging and the specific data exchanged between network entities to enable local sensing services. Also described is a procedure that is triggered once the network recognizes a sensing service request from a user equipment. Embodiments specify control operations and signal flows needed to manage the sensing function and fulfil the sensing service request locally without traversing towards the core network.

Also provided is an apparatus which includes a network entity such as a network function. This network entity does not currently exist in the networks, yet it is necessary to provide sensing services to the customers. Furthermore, this new network entity performs functions that are not currently supported by any other network entity. The new network entity is referred to as “a sensing manager”. The sensing manager, besides other tasks, handles sensing service request interpretation, by converting a sensing service request into machine understandable instructions, and sensor handling.

The sensing manager (SM) may be responsible for determining which sensor or sensors are required for a particular sensing service request and submitting this information to a network node (gNB). The gNB may then communicate with the indicated sensors and may collect the indicated sensors' sensed data. Consequently, the collected sensed data may be sent to the SM for verification and accuracy checks as well as for encoding for privacy preservation. One possible advantage of tasking the SM with determining sensors required for the job is to avoid overly complicated system modifications. The SM may carry all the logic operations required and may fulfill all the necessary computations. Thus, the gNB may still function primarily as a relay and access node ensuring data transport back and forth between terminals.

The SM may be responsible for building a database of available sensors. The database of available sensors may allow the sensing manager to make timely decisions regarding one or more of: feasibility of a sensing task from resources standpoint, type of sensing tasks that can be fulfilled, quality of sensing (QoS) that can be provided given the available sensors, expandability of the database (as new sensors can be easily added to the database), security and privacy of the sensed data collected, accuracy of the collected sensed data with respect to the sensing service request, and locality of the sensing task as the sensing manager has access to the sensing coverage capability of local sensors, etc.

Furthermore, the SM may also be responsible for ensuring sensing QoS and preparing a utility report to be used for billing the user for the sensing service.

Unlike conventional communication service requests, sensing service requests may involve two types of services working together to fulfill a request, namely communication and sensing. While sensing depends on the types and quality of sensors available, it may also be impacted by the quality of communication which is used to collect the sensed data and transmit the sensed data back to the sensing consumer. Thus, in the present disclosure, the SM may handle and monitor the QoS (both the communication and sensing) by the current standardized 3GPP architecture. The SM, may work together with the gNB to fulfill the sensing service request, while the SM may also facilitate meeting of the QoS requirements.

Upon completion of the sensing service task, the SM may generate a resource utility report indicative of the amount of resources consumed. The prepared utility report may be sent to an access and mobility management (AMF) function, for example. In its turn, the AMF may interact with a policy control function (PCF) and a charging function (CHF) to charge the sensing consumer, for example. Possible effects of the disclosed arrangement may include compatibility with the conventional systems and standards, including pay per use type of billing which gives flexibility for both the network and the sensing consumer.

According to embodiments of the present disclosure, a message may be received by a network node providing network access. The received message may be a message on a physical uplink control channel (PUCCH), the message having a standardized uplink control information (UCI) format of type 2, 3 or 4. The received message may contain at least one predetermined bit set to a predetermined value to indicate the sensing service request. Further, according to some embodiments, the message is received on a predetermined wireless communication channel. The predetermined wireless communication channel may convey messages for both a networked sensing service and a networked communication service.

Upon detecting that the message is indicative of a sensing service request (SSR), the SSR may be fulfilled in coordination with a sensing manager function. This detecting may involve differentiating the message from a message indicative of a communication service request. The request may be fulfilled using sensors registered with the sensing manager function.

According to some embodiments, coordination with the sensing manager function may include sending details of the sensing service request to the sensing manager function, wherein the details of the sensing service request including one or both of: a location to be subjected to sensing; and sensing-related information required to fulfil the sensing service request. Further, coordination may include receiving, from the sensing manager function, a first indication of one or more sensors to utilize in fulfilling the sensing service request, and a second indication of sensed data required from each of the one or more sensors. Coordination with the sensing manager function may also include interacting with the one or more sensors according to the first indication and the second indication to obtain the sensed data required from each of the one or more sensors. In some embodiments, interaction with the one or more sensors includes indicating, to each of the one or more sensors, communication resources allocated for use by the sensors in providing the sensed data to the network node, and receiving, via the communication resources allocated for use by the sensors, sensed data usable in fulfilling the sensing service request. Furthermore, after receiving the first indication from the sensing manager function, an initiator of the sensing service request or a related device (a sensing consumer or a user equipment, for example), may receive an indication of communication resources allocated for use in subsequent receiving of the sensed data from the network node or a related device, in association with the sensing service request.

In some embodiments, interaction with one or more sensors may also include initialization of the sensors and maintaining one or both of: registration of the one or more sensors, including locations and capabilities thereof, in a database accessible to the sensing manager; and communication resources usable for communication between the network node and the one or more sensors.

The sensing manager may be interacted with to register the one or more sensors with the sensing manager. Interaction with the sensing manager may comprise: receiving, from the sensing manager, an indication to update status of at least one of the one or more sensors at a specified update frequency; and reporting status of the at least one of the one or more sensors to the sensing manager at the specified update frequency. Alternatively, interaction with the sensing manager may include receiving, from the sensing manager, a request to update status of at least one of the one or more sensors; and reporting status of the sensor the at least one of the one or more sensors to the sensing manager in response to the request. The reported status may comprise one or more of: sensor responsiveness, sensor capabilities, and sensor location.

The present disclosure includes an SSR authentication method. The method may include interaction with an access and mobility management function (AMF) to authenticate the sensing service request prior. This interaction with the AMF may take place prior interaction with the sensing manager function. The AMF may also be operative to authenticate requests to use the networked communication service.

In some embodiments of the present disclosure, after detecting that the message is indicative of a sensing service request, details of the sensing service request may be requested and received. The details of the sensing service request may include one or both of: a location to be subjected to sensing; and sensing-related information required to fulfill the sensing service request.

Some embodiments of the present disclosure may comprise, along with a request for the details of the sensing service request, an indication of communication resources allocated for use in further communications with the network node regarding the sensing service request. The received details of the sensing service request may be communicated via the communication resources.

According to some embodiments, the sensing manager function may comprise a first entity co-located with the network node or located elsewhere at an edge of a communication and sensing network, and a second entity located in a core of the communication and sensing network or elsewhere away from the edge of the communication and sensing network. In some embodiments, sending details of the sensing service request to the sensing manager function may comprise communicating with the second entity. In some embodiments, the first indication and the second indication are received from the second entity. After receiving the first indication and the second indication from the second entity, the first entity may be interacted with to confirm the first indication and the second indication.

The sensing manager function implemented partially or fully at the network edge, and this may have an effect of a low delay for local sensing tasks as these sensing tasks will not need to traverse the network to be fulfilled.

Some embodiments of the present disclosure include receiving sensed data usable in fulfilling the sensing service request. The received sensed data may be provided to an initiator of the sensing service request or a related device after verifying that the received sensed data fulfills the sensing service request. Verification that the received sensed data fulfills the sensing service request may be accomplished by communication with the sensing manager function. Communication with the sensing manager function to verify that the received sensed data fulfills the sensing service request may comprise communicating with the first entity.

In some embodiments, upon determining that the sensing service request has been fulfilled, a utility report may be communicated to an access and mobility management function (AMF) or another network function. The utility report provides an indication that the sensing service request has been fulfilled. The utility report may include an indication of an amount of resources consumed in fulfilling the sensing service request, and may be used in charging for fulfilling the sensing service request.

Yet another embodiment provides one or more network nodes implementing a sensing manager function and a method in conjunction with the one or more network nodes implementing a sensing manager function. The method includes maintaining information indicative of locations and capabilities of one or more sensors local to the sensing manager function. The method further includes receiving, from a network node providing network access, details of a sensing service request, the details of the sensing service request including one or both of: a location to be subjected to sensing; and sensing-related information required to fulfill the sensing service request. The method further includes sending, to the network node providing network access, a first indication of one or more sensors to utilize in fulfilling the sensing service request, and a second indication of sensed data required from each of the one or more sensors, the first indication and the second indication being based on the maintained information. In some embodiments, the method also includes receiving, from the network node providing network access, sensed data potentially usable in fulfilling the sensing service request, the sensed data originating from the one or more sensors; and when the sensed data fulfills the sensing service request, sending, to the network node providing network access, an indication that the sensed data fulfills the sensing service request. In some embodiments, the method includes monitoring and handling one or more quality of service (QoS) requirements pertaining to content of the sensed data, and determining whether the sensing service request can be fulfilled by sensors local to the network node providing network access.

The first indication and the second indication may be sent when the sensing service request can be fulfilled by said sensors local to the network node providing network access.

When the sensing service request cannot be fulfilled by said sensors local to the network node providing network access, an indication that the sensing service request cannot be fulfilled by said sensors local to the network node providing network access may be sent, for example by or via the network node providing network access.

The sensing manager function may include a first entity co-located with the network node providing network access or located elsewhere at an edge of a communication and sensing network, and a second entity located in a core of the communication and sensing network or elsewhere away from the edge of the communication and sensing network.

The second entity may perform maintaining information indicative of locations and capabilities of the one or more sensors, the receiving details of the sensing service request, and the sending the first indication and the second indication. The network node providing network access may interact with the first entity to confirm the first indication and the second indication. The first entity may also perform said receiving sensed data and said sending the indication that the sensed data fulfills the sensing service request.

Upon determining that the sensing service request has been fulfilled, a utility report may be communicated to an access and mobility management function (AMF) or another network function, that the sensing service request has been fulfilled. The utility report may be used in charging for fulfilling the sensing service request.

Yet other embodiments disclose a mobile device accessing a network and a method in conjunction with the mobile device accessing the network. The method includes sending, to a network node providing access to the network: a message on a predetermined wireless communication channel which is used to support both a networked sensing service and a networked communication service. The message may be configured to be indicative of a sensing service request. Further, the message may be a message on a physical uplink control channel (PUCCH), the message having a standardized uplink control information (UCI) format of type 2, 3 or 4. Furthermore, the message may contain at least one predetermined bit set to a predetermined value to indicate the sensing service request. The method further includes receiving a request for details of the sensing service request, the details of the sensing service request including one or both of: a location to be subjected to sensing; and sensing-related information required to fulfill the sensing service request; and sending, to the network node, the details of the sensing service request. Some embodiments provide for a method which includes receiving, along with the request for details of the sensing service request, an indication of communication resources allocated for use in further communications with the network node regarding the sensing service request, wherein the details of the sensing service request are sent via the communication resources. In some embodiments, the method includes receiving, from the network node providing access to the network, sensed data potentially usable in fulfilling the sensing service request; and, when the sensed data fulfills the sensing service request, sending, to the network node providing access to the network, an indication that the sensed data fulfills the sensing service request. In some embodiments, the method also includes determining whether the sensed data fulfills the sensing service request based at least in part on evaluating whether the sensed data meets one or more quality of service (QOS) requirements pertaining to content of the sensed data.

Embodiments provide for a network node providing network access, e.g. a gNB. The network node is configured to receive a message on a predetermined wireless communication channel which conveys messages for both a networked sensing service and a networked communication service wherein the message indicates a request of the networked sensing service. The network node is configured to coordinate with a sensing manager function to fulfill the request of the networked sensing service, using sensors registered with the sensing manager function.

Embodiments provide for an apparatus comprising a sensing manager function implemented by one or more network nodes. The sensing manager function is configured to maintain information indicative of locations and capabilities of one or more sensors local to the sensing manager function. The sensing manager function is configured to receive, from a network node providing network access, details of a request of a networked sensing service, the details of the request of the networked sensing service including one or both of: a location to be subjected to sensing; and sensing-related information required to fulfill the request of the networked sensing service. The sensing manager function is configured to send, to the network node providing network access, a first indication of one or more sensors to utilize in fulfilling the request of the networked sensing service, and a second indication of sensed data required from each of the one or more sensors, the first indication and the second indication being based on the maintained information.

Embodiments provide for a mobile device accessing a network. The mobile device is configured to send, to a network node providing access to the network: a message on a predetermined wireless communication channel which is used to support both a networked sensing service and a networked communication service. The message is configured to be indicative of a request of the networked sensing service.

Embodiments provide for a system comprising, in combination, two or more of the network node, the apparatus and the mobile device as described above.

Embodiments provide for a computer program product comprising a non-transitory computer readable medium having recorded thereon statements and instructions which, when carried out on one or more computers cause the one or more computers to implement the method as described above.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

Further features and advantages of the present invention will become apparent from the following detailed description, taken in combination with the appended drawings, in which:

FIG. 1 is a block diagram of a radio access network (RAN) in communication with a core network (CN) and a user equipment by a sensing consumer.

FIG. 2 is a network node gNB environment with a plurality of sensors in the vicinity.

FIG. 3 is a sensing enabled network node gNB with a sensing manager (SM) co-located with the network node gNB.

FIG. 4 is a flow diagram for enabling local sensing as a service at the network node gNB with ISAC capabilities.

FIG. 5 is a flow diagram of a periodic sensor status update.

FIG. 6 is a flow diagram of a sensor status update upon a request.

FIG. 7 is an environment of a sensing enabled network node gNB with the SM having a hierarchical form.

FIG. 8 is a flow diagram for enabling local sensing at gNB with ISAC capabilities and with the SM in the hierarchical form.

FIG. 9 is a flow diagram of a periodic sensor status update under the E-SM/SM-F control.

FIG. 10 is a flow diagram of a sensor status update upon the E-SM/SM-F request.

FIG. 11 is a block diagram of a user equipment (a mobile device, for example)

It will be noted that throughout the appended drawings, like features are identified by like reference numerals.

### DETAILED DESCRIPTION

Future computing applications and day-to-day activities are expected to heavily rely on a variety of sensory data (autonomous driving, object tracking, remote control, smart farming, virtual reality, etc). Integrated sensing and communication (ISAC) is a new paradigm that enables the mobile network to sense the surrounding via radar-like function. An antenna mounted on a network node gNB sends a signal and monitors for the signal's reflections. A signal processing module at the base station converts the reflections into useful information such as object detection, object classification, or imaging. In addition to the ISAC sensing, the network node gNB may have access to different IoT sensors such as cameras, LIDARs/LADARs, ultrasound sensors, etc. These sensors can communicate their data back to the network wirelessly through a nearby network node.

Yet, even in the future, user equipment is expected to be unable to integrate, on top of its hardware, all the sensors needed to address the requirements of all possible applications. As such, we envision that the future user equipment UEs will rather rely on peripheral, ad-hoc (e.g. roadside) sensors that could be accessed on demand. Consequently, in these future networks, network nodes gNBs are expected to have access to a significant number of sensors with various capabilities such as ISAC enabled antennas, visible light/IR cameras, LIDARs/LADARs, ultrasonic sensors, humidity sensors, etc.

Conventional network nodes gNBs do not have an ability to interpret a detailed sensing request such as “detect the objects in this area” or “count the number of cars in the street”. Such sensing requests are complex to handle by the network with current technology, and instead they are often implemented as part of an application. To enable sensing services of such level of sophistication without relying on third party applications, embodiments of the present disclosure provide a way by which a sensing consumer can communicate its sensing request to the network node gNB directly. Additionally, embodiments provide a way by which the network node gNB can interpret an abstract sensing service request and convert the request into machine understandable instructions.

Numerous R&D projects were focused on developing technologies ensuring global as well as local sensing capabilities integrated with communication networks, wherein the above mentioned global/local sensing capabilities are available to a customer through user equipment (UEs) units. These R&D projects have envisioned several possible applications that can be unlocked by these new technologies. With communication and sensing enabled network architecture, network operators will be able to monetize on-demand sensing services by offering to network customers the sensing services as an added value solution. To fill in gaps in these efforts, embodiments of the present disclosure provide a mechanism for the sensing services to be provided to consumers (on a global and a local scale).

Thus, embodiments of the present disclosure provide for a technology that defines the ISAC capable network as a sensing service provider to a network enabled sensing consumer (a network enabled mobile device or other network enabled device, for example). There is provided a method and a system that define interactions between the sensing consumer (e.g. the mobile device) and its serving network node gNB in the ISAC enabled networks. Furthermore, there is provided steps towards enabling sensing services for a variety of applications on top of the currently implemented and commercially available networks at the lowest possible modification cost. Embodiments of the present disclosure provide a mechanism for a user equipment to place a sensing service request. Other embodiments provide a mechanism for a sensing network node gNB to differentiate between a sensing service request and a communication service request. Yet other embodiments provide mechanisms to differentiate between a local sensing service request and a global sensing service request (i.e., distinguishing between a sensing consumer looking for information from one of the sensors within the coverage area of the serving network node gNB and a sensing consumer looking for information from other network nodes gNBs). Some other embodiments of the present disclosure provide a mechanism for a network to interpret and fulfill a sensing service request, wherein a network node gNB may determine which sensor or sensors (out of a plurality of available sensors) is/are required for the job. Some embodiments address tasks of charging the sensing consumer for the sensing service and ensuring quality of service (QOS) requirements.

Conventionally, a network node (e.g. a gNB) is only attached to an AMF entity in the core which handles the communication services of the network. In that setup, the network node did not have to determine where to send an incoming control signal because there is only one choice, that is, to the AMF. In contrast, in embodiments of the present disclosure, the network node determines how to treat or where to send an incoming control message. The network node inspects an incoming control message and determines if it is indicative of a sensing service request or a communication service request. The network node then handles the message accordingly, for example by sending it to the appropriate management entity, such as an AMF for communication service requests, or a sensing manager function for sensing service requests. Thus the network node may detect that a message indicates a sensing service request at least in part by differentiating the message from one indicative of a communication service request.

Local sensing as a service application does not necessarily require interaction between the consumer and the (e.g. 3GPP) core network. As such, a local sensing task can potentially be handled at the serving network node gNB in a semi-independent manner, and embodiments of the present disclosure encompass such a possibility. Consequently, this disclosure does not explicitly cover issues such as routing, mobility, or handover of a sensing service within a global sensing network, although such capabilities may be present.

A subset of the above-mentioned sensing applications can be classified as local sensing applications. These applications refer to sensing tasks that do not require cross-network connectivity. Rather, they can be fulfilled via local sensors in communication with the serving network nodes (gNB) or the ISAC function of the serving cell. As such, the local sensors or the ISAC sensor of the serving cell may require only local interactions between a network enabled sensing consumer (a network enabled mobile device, for example) and its serving network node gNB. Example applications include a farm requiring a report on local weather conditions, a VR/XR game requiring localized sensing for complete immersive experience, an autonomous vehicle that uses nearby roadside units (RSUs) as peripheral sensors to extend its vision range, etc. For such applications, the serving network node gNB needs to have enough intelligence to be able to fulfill a local sensing task. Conventional mobile networks do not natively provide such services or house needed intelligence at the network nodes gNBs that can fulfill “local sensing as a service” applications.

The IoT sensors along with the ISAC function of the associated network node gNB comprise what may be defined as a local sensing network. A mobile device (a user equipment) requesting sensing information from this local sensing network is said to be using the local sensing as a service function of the mobile network.

Requesting a local sensing service may be a multi-step process. According to an embodiment, the process includes the following. The user equipment connects to the network node gNB. The network node gNB authenticates the user equipment for the service (to ensure that the user is subscribed to a requested service). The user equipment informs the network node gNB of what exactly needs to be sensed. The network node gNB interprets the details of the sensing service task as indicated by the user equipment. The network node gNB determines if the sensing service request is a local or a global sensing service request. For local sensing services, the network node gNB determines if a sensing service can be fulfilled by the available sensing capabilities (engaged IoT sensors and the network node's ISAC ability). The network node gNB then collects the requested sensed data from the IoT sensors and the ISAC function.

The collected sensed data is to be evaluated against the user equipment's sensing service request for authentication and verification purposes. The network node gNB then sends verified data back to the user equipment. The user equipment verifies if the requested sensing service task was completed properly or if more sensed data is needed. If the sensing service task is marked as completed, the network then bills the user or other entity for the sensing service.

For the purposes of this disclosure, it is assumed that the sensor technology is developed and the network is capable of providing sensing functionality, while focus is placed on a method and a system by which a user (UE) can access sensing services.

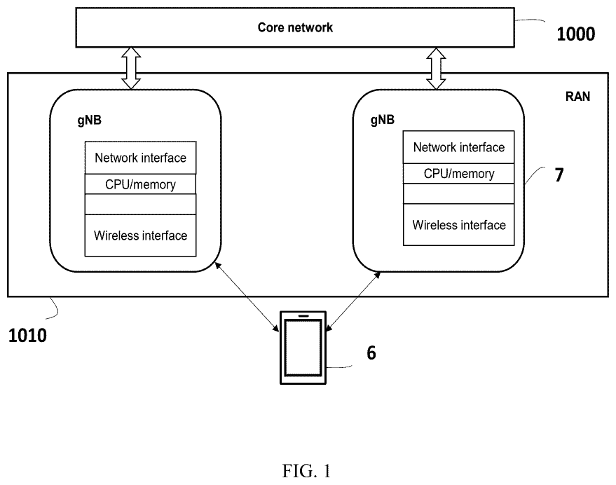

FIG. 1 illustrates a block diagram of a radio access network (RAN) 1010 in communication with a core network (CN) 1000 and a sensing consumer (for example, a UE or mobile device) 6, according to some embodiments. The RAN 1010 comprises a plurality of network nodes (gNB) 7. The sensing consumer 6 can perform tasks such as interacting with a network node 7 to make a sensing service request, receiving sensed data, and determining and indicating whether the sensed data fulfills the sensing service request. Although a network node is shown as being a gNB, other types of network nodes can be used in some embodiments, with the network nodes generally providing access to communication and sensing services via a wireless communication interface.

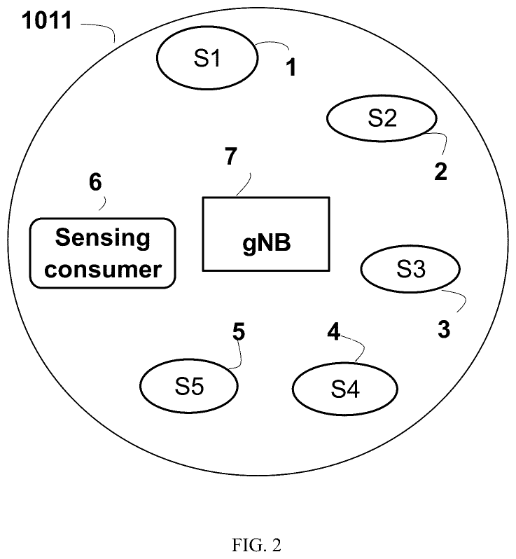

FIG. 2 illustrates an environment of a network node gNB 7 with a plurality of sensors 1 to 5 (although more or fewer sensors may be present). This plurality of sensors 1 to 5 could possibly provide sensing data to a sensing consumer 6. However, conventional network nodes are only used to carry communication data and manage radio resources. Consequently, in conventional networks and without further measures such as those described herein, the gNB 7 is unable to differentiate between a communication service request and a sensing service request submitted by the sensing consumer 6. The sensors are communicatively coupled to the gNB, for example directly, so as to be local to the gNB. The sensors are typically also physically located relatively close to the gNB, for example within direct wireless communication range of the gNB. The sensors thus typically obtain sensor data for a local environment of the sensing consumer, so as to provide for a local sensing service. Although not illustrated, other devices, such as other UEs, sensing consumer UEs, communication service consumer UEs, or the like, can be present within the vicinity of the gNB, and served by the gNB. Thus, embodiments of the present disclosure may involve serving multiple sensing service consumers at a time, multiple communication service consumers, or a combination thereof.

Embodiments of the present disclosure therefore provide for a way to differentiate between a regular communication task and a sensing service task. In various embodiments, to facilitate this, bits from the standard UCI formats 2, 3 or 4 are used as “indication bits”. Other formats could be also used for this objective. This allows the gNB to handle a message from a sensing consumer as either a sensing service request or a communication service request, depending on the value of such bits, as set in the message.

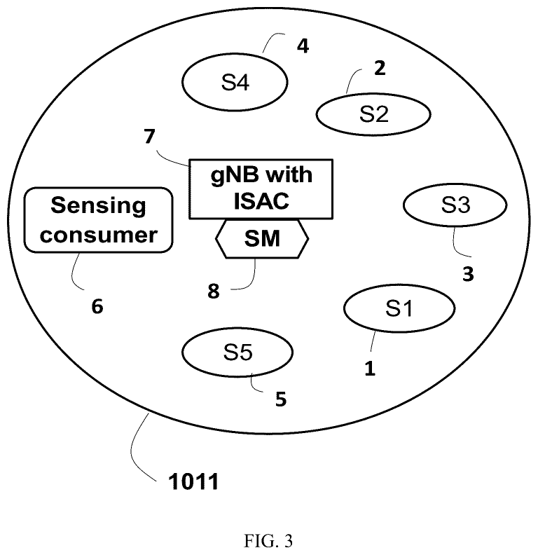

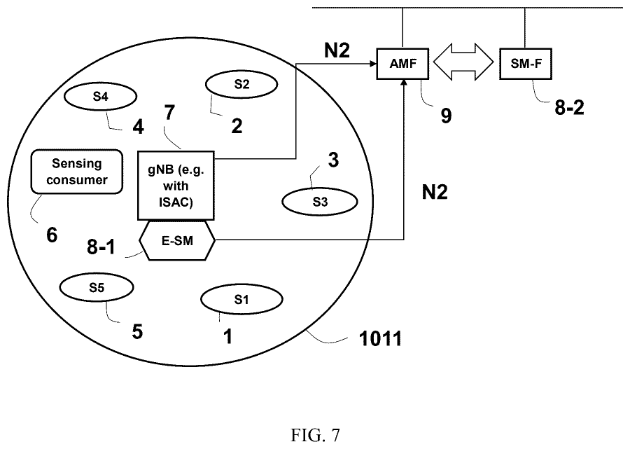

As illustrated in FIG. 3, a sensing consumer 6, be it a UE, a small business, a large corporation, or an electronic device thereof, is to access sensing service, such as a local sensing service, at its serving network node gNB 7. The serving network node gNB 7, in addition to its ISAC capability, can access a broad variety of different types of (e.g. operator owned or other-owned) sensors 1 to 5 such as cameras, LIDARs/LADARs, sonar, temperature sensors, humidity sensors, magnetic sensors, accelerometers, microphones, radio receivers, etc. The sensing consumer 6 may request a local sensing service. The local sensing service is a sensing task that can be fulfilled by the ISAC functionality of the serving network node gNB 7, by a plurality of operator-owned or other-owned sensors 1 to 5, engaged by the serving network node gNB 7, or a combination thereof. A sensing manager 8 is provided and implements a function in charge of (possibly besides other tasks) sensor handling and sensing service request handling. The sensing manager function may be an entity co-located with the network node or located elsewhere at an edge of the network (e.g. at a computing device local to the gNB). The sensing manager function may alternatively include a first entity and a second entity, as illustrated for example in FIG. 7. The first entity (e.g. E-SM 8-1) is co-located with the network node or located elsewhere at an edge of a communication and sensing network. The second entity (e.g. SM-F 8-2) is located in a core of the communication and sensing network or elsewhere away from the edge of the communication and sensing network. As mentioned above, other devices, such as other UEs, sensing consumer UEs, communication service consumer UEs, or the like, can be present within the vicinity of the gNB, and served by the gNB.

An embodiment of the present disclosure as presented below describes implementation of the sensing manager SM 8 as a part of the edge computing network in proximity to an individual network node gNB 7.

The SM 8 collects information about the sensors 1 to 5, which could be IoT sensors, within the coverage area 1011 of the network node gNB 7. The information is collected periodically or upon a request from the SM 8. The information could be collected wirelessly, and, in this case, the sensors 1 to 5, are assumed to have an ability to access the network as serviced by the network node gNB 7. The SM 8 may be in charge of managing and controlling the ISAC function (if present) of the associated network node gNB 7, which may be treated herein as one of the plurality of local sensors. The SM 8 uses the collected information to generate and maintain a database of available sensors which is used to evaluate the sensing ability of the local cell.

The information collected by the SM 8 may include some or all of: energy level of the sensors, location of the sensors, type of sensed data, default size of generated data packets, availability for a sensing task, orientation, and processing capability.

For the ISAC function, the SM 8 collects information for example on some or all of: the available RF resources, beam width, number of antennas, frequency band of operation, and channel state information. An ISAC sensor may be a sensor which detects physical objects based on observations of the RF environment.

For mobile sensors that enter and exit the coverage area, in addition to the above information, a registration process is provided in which the SM 8 authenticates new sensors and assigns IDs for ease of addressing. Mobile sensors may also provide information about their trajectory and speed. Sensing consumers or other devices (e.g. UEs) in the network, equipped with sensors, can also be used to obtain sensing information, which may involve incentives that could be monetary or in any other form. Such devices may be required to fulfill certain trust criteria to become usable sensors.

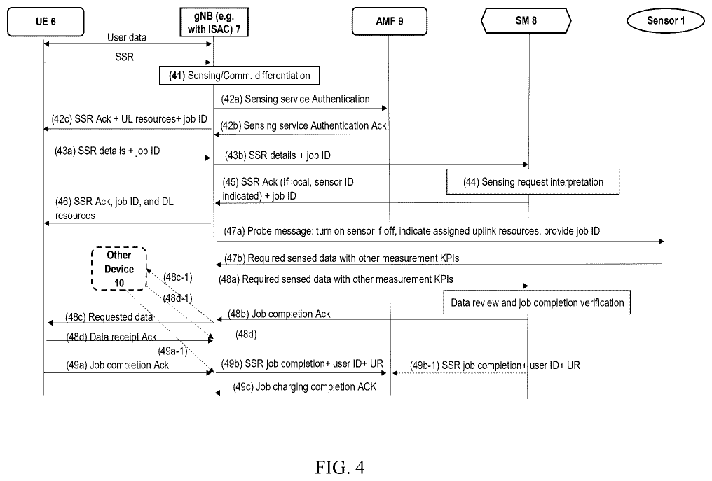

As illustrated in FIG. 4, a sensing consumer (in this case, it is a UE 6) sends an uplink message towards its serving network node gNB 7 to indicate a request for a task to be performed. When the task is a sensing service and the message is a sensing service request message, the UE 6 will use a format, capable of supporting an adequate number of bits to indicate same. As such, the message may be a message on a physical uplink control channel (PUCCH), having a standardized uplink control information (UCI) format of type 2, 3 or 4. In this disclosure, UCI format 2, 3, or 4 may be referred to as “a sensing format.” A few bits of the sensing format can be utilized as indication bits to differentiate between a request for communication service and a sensing service request. In some embodiments, the sensing format relies on bit-based control signaling which is already in use in telecommunications. By using the UCI to indicate if a request message is a sensing service request or a communication service request, embodiments of the disclosure align with the current network architecture and the present disclosure may be readily incorporated into the standard with minimal system modifications.

Thus, the details of the sensing service request may be standardized and encoded into bits that are readily recognized by the network (e.g. with limited processing required) and translated into understandable instructions by the SM. A sensing consumer (a mobile device) may indicate the details of sensing service request through the standardized uplink control (UCI) and downlink control (DCI) communication resources.

More generally, the sensing service request is transmitted on a predetermined wireless communication channel which conveys messages for both a networked sensing service and a networked communication service (e.g. messages conveying user data), and the network node gNB receives this sensing service request.

In various embodiments, the sensing service request message comprises the indication bits or is otherwise configured to indicate to the gNB that it is a sensing service request. At least one predetermined bit of the indication bits may be set to a predetermined value to indicate that the message pertains to the sensing service request. The gNB 7 reads these bits (or other indication) to detect 41 that the message is indicative of a sensing service request (SSR). The gNB thus differentiates between messages related to sensing and messages related to other operations such as communications. If the message is indicative of another operation, the gNB can handle the message in another manner accordingly.

After such a detection, a series of authentication processes with the AMF 9 may be initiated. This can include the gNB 7 sending a sensing service authentication request 42a to the AMF 9, receiving a sensing service authentication acknowledgement 42b from the AMF 9 if the authentication is successful, and sending a further message 42c to the UE 6 upon receipt of the acknowledgement 42b.

In more detail, the AMF authentication processes, e.g. involving messages 42a, and 42b have an objective to ensure that the UE 6 has the proper subscription to the sensing as a service, or is otherwise allowed to use the sensing service. The AMF 9 is thus operative to authenticate requests to use the network communication service. Furthermore, the AMF 9 may also handle the UE 6 mobility for both communication and sensing services: if the UE 6 moves out of the coverage of the current network node gNB 7 into the coverage of another gNB, the AMF 9 may redirect the sensing data towards the new cell.

After the UE 6 is authenticated by the AMF 9, the current network node gNB 7 may assign a unique job ID (e.g. an integer vector containing a temp ID, when mixed with the UE ID, becomes substantially unique) to be used by the UE 6 and gNB 7 for labelling and tracking interactions related to the requested sensing service. The gNB 7 also indicates the uplink (UL) communication resources assigned for the UE 6 to communicate the details of its sensing service request. The gNB 7 assigns the task to a local SM 8 by indicating the job ID and the UE ID. A current network node gNB 7 may be associated with one or more SMs depending on the size of the cell and the number of sensors in coverage. The gNB 7 acknowledges the service indicating that the UE 6 is authenticated. The above, including the assigned job ID, assigned UL resources, and acknowledgement, can be included in the further message 42c sent from the gNB 7 to the UE 6 following authentication (if authentication is performed).

After the UE 6 sensing service request is authenticated and assigned with the UL communication resources on the UL-control channel, the UE 6 uses the sensing format to send (in a message 43a which also includes the assigned job ID) details about the sensing service request back to the network node gNB 7. The details of the sensing service request can include a location to be subjected to sensing, and sensing-related information required to fulfill the sensing service request. Sensing-related information can include, for example, what type of sensing information is required, the resolution of the sensing information, the quality of the sensing information, a time window for the sensing information, etc. In some embodiments, the details of the SSR may be appended to the original sensing service request message of the UE 6. Thus, message indicating the sensing service request, or a companion message, includes details of the sensing service request. The details of the sensing service request include one or both of: a location to be subjected to sensing; and sensing-related information required to fulfill the sensing service request. In other words, the original sensing service request message or a follow-up (e.g. upon request) message may include such details.

The list of available sensing functions at each gNB may be periodically updated by the SM. The list may then be advertised to all sensing consumers UEs in the coverage area. The advertisement could be in the form of a broadcast on the broadcast channel or signaled along with the authentication signal. Each sensing function on the list may have a specific indication code that would be known to both the UE and the gNB. A sensing consumer UE may then use a few of the sensing format bits to signal the code of the desired sensing function from the advertised list. The number of engaged sensing format bits depends on the number of possible sensing functions the gNB can handle. As for the location information, this information may be provided via any location indication methods, such as longitude and latitude, as long as the information can be coded using the rest of the sensing format bits. The gNB then extracts the information and sends it to the sensing manager SM for further processing.

After receiving the message 43a, the network node gNB 7 sends, to the assigned SM 8, the sensing service request details 43b, including the location that needs to be sensed, and nature of the sensing task. The job ID may also be included.

This information may be used by the assigned SM 8 to determine the locality and the feasibility of the sensing task, which may be performed as part of an interpretation 44 of the sensing request. The sensing request interpretation can additionally or alternatively include actions such as determining how to fulfill the sensing request, determining what sensors to use in fulfilling the sensing request, determining instructions to send to the such sensors, etc. To determine locality and feasibility, the SM compares the location of the sensing service task vs the reach/coverage of the available local sensors. If the location of the task is within the coverage area, then the task is considered local. However, not all local tasks are feasible as feasibility depends on the nature of the task and the available sensing capabilities. For instance, if the sensing consumer needs to sense the humidity level right in the middle of the coverage cell, but the SM does not have access to a humidity sensor at the moment of the sensing service request, then this task is considered local but infeasible. Thus, in various embodiments, a sensing service request (SSR) is only admitted by the SM if the SSR is local and feasible. The SM can use a two-bit acknowledgment system to differentiate between four cases, namely: a local and feasible SSR, a local but infeasible at the moment SSR, a local but infeasible due to lack of sensors SSR, and a non-local (e.g. global) SSR.

In the present embodiment, and by way of example, if the SSR is local and feasible, the SM sends two positive bits (e.g. ‘1’) which indicates the task admittance. If the SSR is local but infeasible at the moment of the request due to loading conditions for instance, then a positive bit followed by a negative bit (e.g. ‘0’) would be communicated indicating a possible delay. If the SSR is local but infeasible due to lack of the required sensors, then a negative bit followed by a positive bit are communicated indicating denial of service and refusal of this type of sensing tasks. The sensing users may retry the same SSR after consulting an updated list of available sensing services. And finally, if a SSR is not local, then two negative bits are communicated.

If the SSR is local and feasible, along with the acknowledgement, the SM 8 communicates back to the gNB 7 a message 45 with a first indication of one or more sensors (for example, sensor(s) ID(s)) to utilize in fulfilling the sensing service request, and a second indication of sensor data required from each of the one or more sensors. The first indication and the second indication are based on the maintained information. The first and second indications can be separate or integrated together.

In the case when the sensing service request cannot be fulfilled by the sensors local to the network node providing network access gNB, the SM indicates to the gNB that the sensing service request cannot be fulfilled. More generally, if the SSR cannot be fulfilled the SM, the AMF, the gNB, or a combination of thereof may generate an informative message. The informative message may be consequentially propagated to the respective sensing consumer.

If the SSR is recognized by the SM 8 as local and feasible, the UE 6 is admitted to the local sensing service and assigned downlink (DL) resources that will be subsequently used to communicate the sensed data. Accordingly, a message 46 is sent from the gNB 7 to the UE 6, including an acknowledgement of the SSR, the job ID, and an indication of the assigned DL resources for subsequent monitoring by the UE 6.

Also after receiving the message 45 from the SM 8, the gNB 7 may establish connectivity with the one or more sensors, these sensors being identified according to the first indication carried in the message 45. In this embodiment the first indication identifies the sensor 1. Connectivity to the sensor 1 may be established via a respective probe message 47a. The probe message 47a may include an instruction to turn on an addressed sensor (in this embodiment this is the sensor 1), to cause the addressed sensor to provide specified measurements in a specified manner, or the like. The probe message 47a may further indicate assigned UL resources to be used by the sensor 1 in communicating sensed data to the gNB 7 (e.g. in message 47b). The probe message 47a may further include a job ID which the sensor 1 may include in subsequent reports of sensed data. The probe message 47a may be configured to reflect or specify parts of the second indication of sensor data required from the sensors. The probe message 47a may specify UL resources to be used by the sensor 1 in providing the sensed data.

The sensor 1 in receipt of the probe message 47a may then collect the required sensed data, for example as indicated in the probe message 47a, and send it back to the gNB 7 using indicated UL resources via response message 47b. Other measurement key performance indicators (KPIs) may be included in the response message. Probe and response messages 47a, 47b may be sent to and from each one of one or more sensors from which sensor data is to be collected in support of the SSR.

The network node gNB 7 providing network access, after receiving the required sensed data together with the KPIs, may then send a message 48a with the sensed data and the KPIs to the SM for verification and validation. If the sensed data is valid and verified with respect to the UE request, the SM 8 may send to the gNB 7 an indication 48b that the sensed data fulfills the sensing service request. The SM may process the sensed data to determine whether it fulfills the SSR and thus whether the sensing task is complete. This may involve comparing the sensed data to the information provided by the SM in message 45. Following the verification and validation of the requested sensed data at the SM 8, the gNB 7 may send a message 48c with the requested sensed data to the UE 6 using the assigned DL resources. In response, the UE 6 may send an acknowledgement message 48d indicative that the data has been received.

The UE 6 may additionally validate the requested sensed data as fulfilling its requirements. That is, the UE may determine whether the sensed data fulfills the sensing service request. It is noted that, in the above, both the SM and the UE perform actions to verify or validate the sensed data. In other embodiments, only one of the SM and the UE perform actions to verify or validate the sensed data.

In some embodiments, the UE (or the SM) may indicate that the received sensed data does not fulfill the sensing service request. In such an event, the UE may notify the SM that the sensing service request is not fulfilled. Subsequently, upon direction of the UE, the sensing service may end without fulfillment, or the sensing service may be re-attempted, with an indication to the SM to improve on the reported sensed data.

If validation at the UE 6 is successful, the job is considered fulfilled, and the UE 6 may send a job completion acknowledgement message 49a to the gNB 7. The job completion acknowledgement may be propagated to the SM 8. The SM 8 in its turn may then close the sensing service request and prepare a utility report (UR). The utility report may include an indication of an amount of resources consumed in fulfilling the sensing service request. The utility report is forwarded toward the AMF 9 via the gNB 7 using a message 49b. Alternatively, the utility report may be sent using a message 49b-1 from the SM 8 to the AMF 9 without involving the gNB. The utility report may include the user ID and an acknowledgement that the SSR was closed. More generally, the gNB, the SM, or a combination thereof, may generate a utility report indicative of resources consumed in fulfilling the sensing service request. The AMF 9 may use the utility report to bill the UE 6 or associated user for the sensing service. The AMF 9 may communicate to the gNB 7 (or alternatively to the SM) an acknowledgement message 49c indicative that job charging is completed.

In some embodiments, in addition to, or alternatively to, sending the sensed data to the UE 6 and subsequent communication with the UE, communication regarding the sensed data can involve another device 10, or multiple other devices. The other device can be another UE local to the gNB or local to another gNB, a designated data storage device, or another networked electronic device directly or indirectly coupled to the gNB via wired or wireless link. The other device 10 can be a virtualized device located in the cloud, a remote computer, etc. The other device 10 can be designated in previously communicated sensing service request details or subsequently. As illustrated, instead of or in addition to sending the message 48c with the requested data to the UE 6, the gNB (or other associated device) can send a message 48c-1 with the requested data to the other device 10. The other device 10 may send an acknowledgement message 48d-1 to the gNB indicative that the data has been received. In some embodiments, the other device may also send the job completion acknowledgement 49a-1 to the gNB or other associated device, indicative that the sensing task has been fulfilled, for example after analyzing the data.

Some embodiments of the present disclosure may include different ways to charge a sensing consumer for the provided services. Additionally, or alternatively to the charging procedure, disclosed above, the SM, the AMF, the gNB, or a combination thereof, may generate a cost estimate for a sensing service request. The cost estimate may be provided to the sensing consumer prior fulfilling the SSR if the sensing consumer approves the cost estimate. If the sensing consumer disapproves the cost estimate, the SSR may be discarded. Some embodiments of the present disclosure may include additional or alternative procedures to negotiate cost estimate of the SSR, additional or alternative payment procedures (prepaid, for example).

In various embodiments, the SM interacts with sensors for the purposes of registration of the sensors in a database of sensors. The sensor registration information can comprise their locations and capabilities. The database of sensors is accessible by the sensing manager SM. The SM may additionally or alternatively interact with the sensors to assign communication resources usable for communication between the sensors and the network node gNB. Sensing service requests can then be fulfilled using sensors registered with the SM. Such sensors may be local to the network node and used for sensing tasks. The network node and SM thus facilitate access to a variety of sensors.

For the sensing manager SM to be able to fulfill its responsibilities, e.g., updating the list of available local sensing services, checking locality and feasibility of a sensing service request, indicating which sensor(s) shall be used for the sensing task, and preparing a utility report for billing the user, the SM maintains a database of the available sensors. The present disclosure details two procedures by which the SM can build and maintain such a database: a procedure based on periodic updates, and a procedure with an on-demand update of the database of available sensors. It should be noted that the following procedures are applicable for both (e.g. operator owned or other-owned) IoT sensors and the ISAC function at the network node gNB. For sensors with mobility feature, or those that enter and exit the local cell (i.e., only temporarily available), an authentication and authorization step may be used to assign a temporary sensor ID before such temporarily available sensors can be added to the sensing database. These temporary sensor IDs will be used to communicate with those types of sensors and may be discarded once they exit the cell or no longer volunteer their sensing resources.

In the case of periodic sensor status update, the procedure comprises receiving, from the sensing manager (SM), an indication (e.g. request) to update status of at least one sensor at a specified update frequency. The procedure further includes, in response to the indication, reporting status of the at least one sensor to the sensing manager periodically according to the specified update frequency. The reported status can include sensor responsiveness, sensor capabilities, and sensor location.

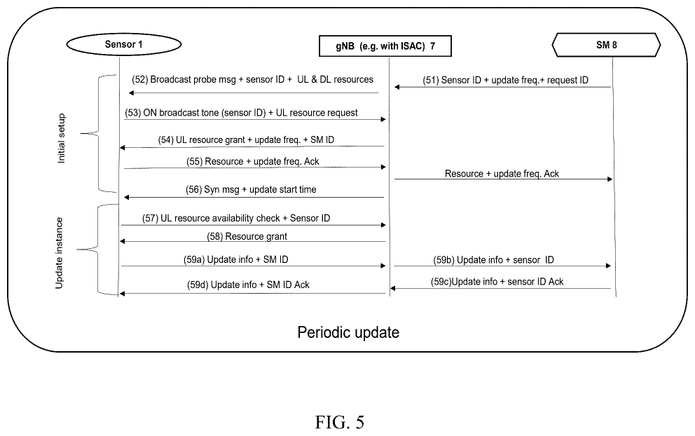

FIG. 5 illustrates an embodiment of periodic sensor status update flow, provided by way of example and described below.

During the initial setup, the SM 8 sends a message 51 with an update frequency, a request ID, and a sensor ID to the gNB 7. In this embodiment, the sensor, identified by the sensor ID in the message 51 is the sensor 1. On a dedicated DL channel, called herein a physical downlink sensor control channel (PDSCCH), the network node gNB 7 sends a broadcast probing message 52 that contains the sensor ID and assigned UL & DL communication resources to be used for sensor control and communication. Sensors monitor the PDSCCH, for example periodically, and once a sensor detects a message with its ID (in this embodiment it is the sensor 1), the sensor 1 responds by sending out a message 53 broadcasting an “ON” signal (e.g. tone) (the sensor ID) on the assigned UL communication resources. Sensors requiring more “data” UL resources also use the message 53 to request for more UL resources. In response to the message 53, the gNB 7 sends back to the sensor 1 on the assigned DL control resources a message 54 to acknowledge (ACK) the requested resources. The message 54 also comprises update frequency details, the request ID, and the ID of SM 8. After receiving the message 54, the sensor 1 sends a message 55 back to the gNB 7 acknowledging assigned UL communication resources and updated frequency. In the end of the initial setup, the gNB 7 communicates to the sensor 1 a synchronization message 56 with the update start point in time.

The sensor 1 waits until the beginning of each update instance and checks if the assigned UL resources are available by sending a broadcast message 57 indicating the sensor ID and request ID. If resources are available, the gNB 7 sends a resource grant message 58 on the assigned DL resources. Responsive to the receipt of message 58, the sensor 1 sends a message 59a with the requested update and the ID of SM 8. The message 59a is sent back to the gNB 7 on the assigned UL resources. The network node gNB 7 relays the update info together with the sensor ID towards the SM 8 in a message 59b. The SM 8 acknowledges the receipt of the message 59b with the update info and the sensor ID by sending back to the gNB 7 a message 59c. Upon receipt of the message 59c, the network node gNB 7 relays to the sensor 1 a message 59d acknowledging the receipt of the update info by the SM 8. The message 59d contains the SM ID.

In the case of sensor status update upon a request, the procedure comprises receiving, from the sensing manager, a request to update status of at least one of the sensors, and, consequently, reporting status of such at least one of the sensors to the sensing manager, in response to the request. The reported status can include sensor responsiveness, sensor capabilities, and sensor location.

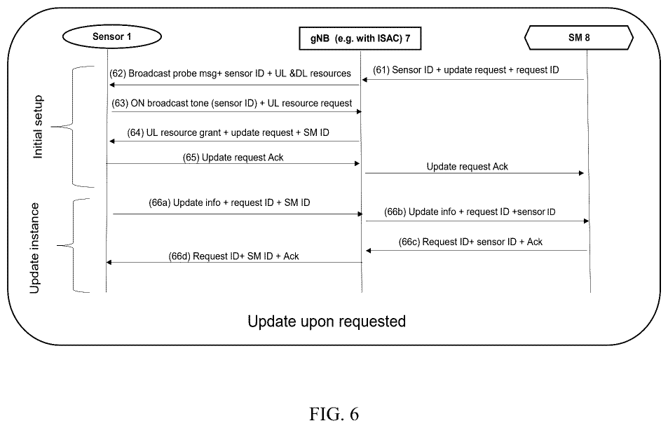

FIG. 6 illustrates an embodiment of sensor status flow updated upon a request, provided by way of example, and described below.

During the initial setup the SM 8 sends an update request message 61 to the gNB 7. The message 61 contains a request ID and a sensor ID. In this embodiment the sensor selected by the SM 8 is the sensor 1. Accordingly, the sensor ID corresponds to the sensor 1. Responsive to the message 61, the gNB 7 broadcasts a probing message 62. The probing message 62 contains the sensor ID and assigned UL & DL resources to be used for control and communication. The probing message 62 is broadcasted on a dedicated DL channel (PDSCCH). Sensors monitor the PDSCCH periodically, and once a sensor (in this embodiment it is the sensor 1) detects a message with its ID, the sensor 1 responds with a message 63 broadcasting an “ON” signal together with the sensor ID. The message 63 is broadcasted on the assigned UL control resources. Sensors requiring more “data” UL resources also use this step to request more resources. The gNB 7 responses to the message 63 by sending on the assigned DL control resources a message 64 acknowledging (ACK) the UL requested resource grant and sending along the update request details, the request ID, and the SM ID. In this embodiment the SM ID corresponds to the SM 8. The sensor 1 acknowledges the receipt of the message 64 by sending back to the gNB 7 a message 65 (update request ACK). The gNB 7 relays the update request ACK to the SM 8.

During the update instance phase, the sensor 1 sends a message 66a with the requested update information and the SM ID. The message 66a is sent to the gNB 7 on the assigned UL resources. The network node gNB 7 relays the requested update information together with the request ID and the sensor ID in a message 66b to the SM 8. In response to the message 66b, the SM 8 sends back to the gNB 7 an acknowledging message 66c. The message 66c contains the request ID and the sensor ID. Responsive to the message 66c, the gNB 7 relays the acknowledge of requested update info receipt in a message 66d to the sensor 1. The message 66d contains the request ID and the SM ID.

The sensing manager function may include a first entity (referred to herein as E-SM) co-located with the network node gNB or located elsewhere at an edge of a communication and sensing network, and a second entity (referred to herein as SM-F) located in a core of the communication and sensing network or elsewhere away from the edge of the communication and sensing network. Thus, the SM may be separated into at least two interoperating parts. This allows for the SM to provide quick responsiveness via its edge-located part, and to use readily abundant resources via its core-located part. Additionally or alternatively, the edge-located part is well-placed to interact with other edge-adjacent devices such as sensors to facilitate some SM functionality, while the core-located part is well-placed to interact with core network functions to facilitate other SM functionality.

FIG. 7 illustrates an embodiment of the sensing manager function in a multi-part or hierarchical form. The first entity E-SM 8-1 is co-located with the gNB 7. The first entity E-SM 8-1 is responsible for local management and control. The second entity SM-F 8-2 is integrated in the 3GPP service based architecture. The SM-F 8-2 is responsible for core functions such as policy control, charging, determination of locality of a sensing, and mobility management from sensing point of view. The E-SM 8-1 collects information about the available sensor or the available sensors within the coverage area 1011 of the attached network node gNB 7 and updates a database of sensors at the SM-F 8-2. In this embodiment the coverage area 1011 comprises sensors 1 to 5. The information about the available sensors is collected periodically or upon a request from the E-SM 81. The information can be collected wirelessly. The E-SM 8-1 is configured to manage and control the ISAC function of the gNB 7. Based at least in part on the collected information content, the SM-F 8-2 generates a database of available sensors. The database of available sensors can be used to evaluate the sensing ability of the local cell. The collected information may include some or all of: energy level of the sensors, location, type of sensed data, default size of generated data packets, availability for a sensing task, orientation, and processing capability. The E-SM 8-1 authenticates new sensors. The new sensors may be mobile sensors entering and exiting the coverage area 1011. The E-SM 8-1 assigns IDs to the new sensors for ease of addressing.

Mobile sensors entering and exiting the coverage area may correspond to a semi-dynamic sensing environment, which may be provided according to embodiments. In such an environment, the local sensing capability of a network node is not fixed in time but rather depends for example on the type of available sensors, locations of the sensors, number of attached sensors. For the ISAC capability, the sensing capability may depend on the available sensing bandwidth which is also variable depending on the loading conditions at the network node. All these parameters can vary with time. Sensors may arrive and depart, or become available or unavailable at different times, and accordingly a database of sensors may be kept and managed by the sensor manager. Other sensors may be more or less consistently and constantly available. In some embodiments, more sensors can be deployed on an as-needed basis, for example upon request from the network node in areas with high demand. For instance, an operator may have sensors mounted on drones and which can be deployed as needed.

For the ISAC function, the E-SM 8-1 collects information for example on some or all of: the available RF resources, beam width, number of antennas, frequency band of operation, and channel state information.

Sensing consumers in the network may be also used to obtain sensing information, which may involve monetary incentives or other incentives. The sensing consumer 6 may need to fulfill certain trust criteria.

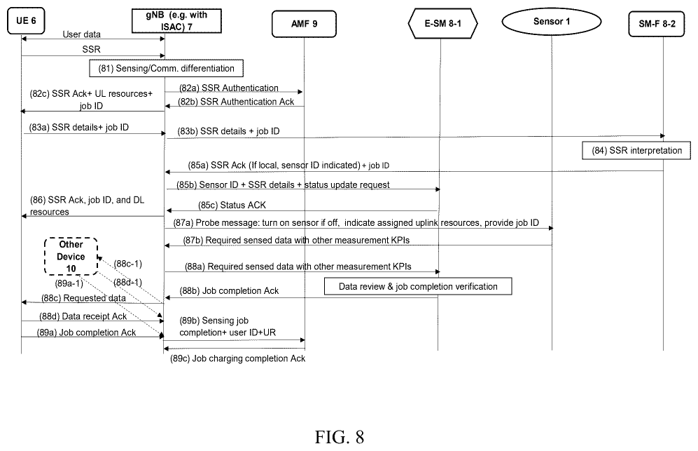

FIG. 8 illustrates yet another embodiment of local sensing at the network node gNB 7 with the sensing manager SM 8 in the hierarchical form. Various operations of FIG. 8 are similar to those of FIG. 4, except that the SM is provided in two parts.

In this embodiment the SM-F 8-2 is a part of the core functions, and the database of the sensors is created and maintained at the core network. To further improve security of the collected data, the SM-F may be implemented close to the cloud RAN or as a part of data centers.

The network node gNB 7 receives a message on a predetermined wireless communication channel which conveys messages for both a networked sensing service and a networked communication service. The message may comprise the indication bits. At least one predetermined bit of the indication bits may be set to a predetermined value to indicate the sensing service request. The gNB 7 reads the indication bits (or other indication) to detect 81 that the message is indicative of a sensing service request (SSR). The gNB 7 thus differentiates between messages related to sensing and messages related to other operations such as communications. If the message is indicative of another operation, the gNB 7 may handle the message in another manner accordingly.

After the detection 81, a series of authentication processes with the AMF 9 may be initiated. The gNB 7 may send a SSR authentication request 82a to the AMF 9, receive back from the AMF 9 a SSR authentication acknowledgement 82b if the authentication is successful, and send a further message 82c to the UE 6 upon receipt of the acknowledgement message 82b.

In more detail, the AMF authentication processes, e.g. involving messages 82a, and 82b have an objective to ensure that the UE 6 has a proper subscription to the sensing as a service, or is otherwise allowed to use the sensing service. The AMF 9 is thus operative to authenticate SSRs to use the network communication service.

The AMF 9 handles UE communication mobility: when the UE 6 moves out of the coverage area of the current network node gNB 7 into the coverage area of another gNB, the AMF 9 redirects communication related data towards a new cell. The SM-F 8-2 handles mobility for sensing: if the UE 6 moves out of the coverage area of the gNB 7 into the coverage area of another gNB, the SM-F 8-2 redirects the sensing data and sensing task towards the new cell.

After the UE 6 message SSR is authenticated by the AMF 9, the current network node gNB 7 may assign a unique job ID (e.g. an integer vector containing a temp ID, when mixed with the UE ID, becomes substantially unique) to be used by the UE 6 and gNB 7 for labelling and tracking interactions related to the RSS. The gNB 7 also indicates the uplink (UCI) communication resources assigned for the UE 6 to communicate SSR details. The gNB 7 assigns the task to a local SM by indicating the job ID and the UE ID. A current network node gNB 7 may be associated with one or more SMs depending on the size of the cell and the number of sensors in the coverage area. The gNB 7 acknowledges the service indicating that the UE 6 is authenticated. The above, including the assigned job ID, assigned UL resources, and SSR acknowledgement, may be included in a further message 82c sent from the gNB 7 to the UE 6 following authentication (if authentication is performed).

Responsive to the message 82c receipt, the UE 6 send back to the gNB 7 a message 83a comprising the job ID and SSR details. The UE 6 may use the sensing format to send the SSR details. The details of the sensing service request may include a location to be subjected to sensing, and sensing-related information required to fulfill the sensing service request.

The list of available sensing functions at each gNB may be periodically updated by the SM. For example, the SM-F may periodically update the list of available sensing functions. The list may then be advertised to all sensing consumers UEs in the coverage area. The advertisement could be in the form of a broadcast on the broadcast channel or only signaled along with the authentication signal. Each sensing function on the list may have a specific indication code that would be known to both the UE and the gNB. A sensing consumer UE may then use a few of the sensing format bits to signal the code of the desired sensing function from the advertised list. The number of engaged sensing format bits depends on the number of possible sensing functions. As for the location information, this information may be provided via any location indication methods, such as longitude and latitude, as long as the information can be coded using the rest of the sensing format bits.

The current network node gNB 7 communicates with the sensing manager function. In this embodiment, the sensing manager function comprises a first entity E-SM 8-1 co-located with the network node or located elsewhere at the edge of a communication and sensing network, and a second entity SM-F 8-2 located in a core of the communication and sensing network or elsewhere away from the edge of the communication and sensing network. As illustrated, the gNB may communicate with both the first entity and the second entity. In other embodiments the gNB may communicate with only one of the two entities. Responsive to the message 83a, the gNB 7 sends to the assigned SM-F 8-2 a message 83b. The message 83b comprises the job ID together with the SSR details. The SSR details may comprise the location that needs to be sensed, and sensing-related information required to fulfill the sensing service request.

The SSR details are used by the assigned SM-F 8-2 to determine the locality and the feasibility of the sensing task. The SM-F 8-2 may compare, as part of a sensing request interpretation 84, the location of the SSR with the coverage area of the local sensors. If the location of the task (SSR) is within sensor coverage area, then the task is considered local. However, not all local tasks are feasible as feasibility depends on the nature of the task and the available sensing capabilities. In various embodiments, a sensing service request is only admitted by the SM-F 8-2 if the SSR is local and feasible. (If the task is global, the SM-F 8-2 will forward the task to the right E-SM.) The SM-F 8-2 uses an acknowledgment system (for example, a two-bit acknowledgment system) to communicate back to the UE 6 the information on locality and feasibility of the requested sensing service. The sensing request interpretation 84 may include other actions such as determining which sensors are to be used to fulfil the sensing request, and determining instructions to send to such sensors.

The SM-F 8-2 may be in control of the database of sensors. After receiving the message 83b, the SM-F 8-2 may determine a first indication of one or more sensors (for example, sensor(s) ID(s)) to utilize in fulfilling the sensing service request, and a second indication of sensor data required from each of the one or more sensors. Consequently, the first indication and the second indications may be sent to the gNB 7 in a SSR acknowledgement message 85a. Besides the first indication and the second indication, the message 85a may comprise a sensor ID or sensors IDs and the job ID. After receiving the first indication and the second indication from the second entity SM-F 8-2, the gNB 7 may interact with the first entity E-SM 8-1 to confirm the first indication and the second indication. The gNB 7 may send a status update message 85b to the E-SM 8-1. The message 85b comprises the sensor ID, the SSR details, and the status update request. Responsive to the message 85b, the E-SM 81 may send back to the gNB 7 a status message 85c. If the E-SM 8-1 determines, after assessing the first and the second indications, that the database of sensors is not up to date, it may start a sensor or sensors update cycle to update the database of sensors at the SM-F 8-2. Once the database of sensors is updated, the SM-F 8-2 may re-run the sensor choice algorithm, update the first and the second indications, and may send the updated set to the gNB 7. After getting the updated set of the first and second indications, the gNB 7 may move on with the sensing task fulfillment.

If the UE 6 SSR is recognized by the SM-F 8-2 as local and feasible, the UE 6 (or any other device initiated the sensing service request) may be admitted to the local sensing service and assigned downlink (DL) communication resources to be used to communicate the sensed data from the network node gNB 7 or a related device, in association with the sensing service request. The gNB 7 may send to the UE 6 a SSR acknowledgement message 86 comprising the job ID and indication of the assigned DL resources. Also, the gNB 7 may establish connectivity with each of the one or more sensors, and indicate to the sensors the assigned uplink UL communication resources allocated for use by the sensors in providing the sensed data to the network node gNB 7. In this embodiment the gNB 7 establishes connectivity with the sensor 1 by sending a probe message 87a comprising the job ID and indication of the assigned UL resources. The message 87a may be also used to turn on the sensor 1.

Responsive to the message 87a, the sensor 1 may then collect the required sensed data and send it back (via the UL communication resources allocated for use by the sensor 1) to the gNB 7. A message 87b carrying the required sensed data to the gNB 7 may also include other measurement key performance indicators (KPIs). The gNB 7 may forward the required sensed data and the KPIs to the E-SM 8-1 for verification and validation in a message 88a. If the data is valid and verified with respect to the UE 6 sensing service request, the E-SM 8-1 sends to the network node gNB 7 an indication that the sensed data fulfills the sensing service request in a message 88b (job completion ACK).

The requested sensed data is communicated to the UE 6 (or any other initiator of the sensing service request) on the assigned UL resources in a message 88c. In response, the UE 6 may send an acknowledgement message 88d indicative that the data has been received.

Responsive to the message 88c, the UE 6 may then validate the requested sensed data: if validation is successful, the job is considered fulfilled, and a job completion acknowledgement message 89a may be sent by the UE 6 to the gNB 7. The job completion acknowledgement may be propagated towards the E-SM 8-1 (or SM-F 8-2) which then closes the SSR and prepares a utility report (UR). The utility report may include an indication of an amount of resources consumed in fulfilling the sensing service request. The utility report is forwarded toward the AMF 9 via the gNB 7 using a message 89b. Alternatively, the utility report may be sent using a message (not shown) from the E-SM 8-1 or SM-F 8-2 to the AMF 9 without involving the gNB. The AMF 9 may communicate to the gNB 7 (or alternatively to the E-SM or SM-F) an acknowledgement message 89c indicative that job charging is completed.

Similarly to FIG. 4, instead of or in addition to sending the message 88c with the requested data to the UE 6, the gNB (or other associated device) can send a message 88c-1 with the requested data to another device 10. The other device 10 may send an acknowledgement message 88d-1 to the gNB indicative that the data has been received. In some embodiments, the other device may also send the job completion acknowledgement 89a-1 to the gNB or other associated device, indicative that the sensing task has been fulfilled, for example after analyzing the data.

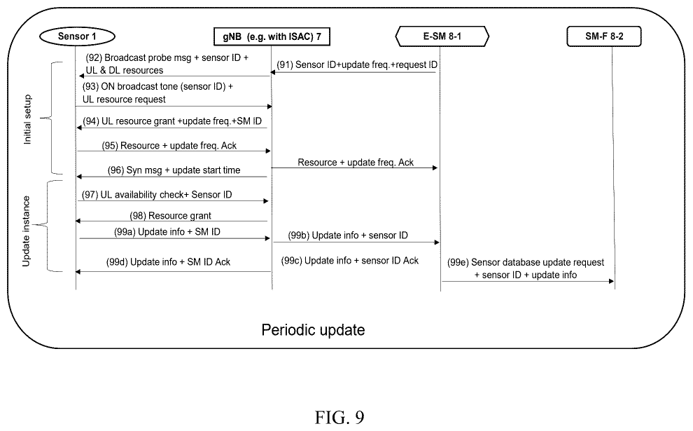

FIG. 9 illustrates an embodiment of periodic sensor status update flow with the sensing manager in the hierarchical form, provided by way of example and described below.

During the initial setup, the E-SM 8-1 sends a message 91 comprising an update frequency, a request ID, and a sensor ID to the gNB 7. In this embodiment, the sensor, identified by the sensor ID in the message 91 is the sensor 1. On a dedicated DL channel, called herein a physical downlink sensor control channel (PDSCCH), the network node gNB 7 sends a broadcast probing message 92 that contains the sensor ID and an indication of assigned UL & DL communication resources to be used for sensor control and communication. Sensors monitor the PDSCCH, for example periodically, and once a sensor (in this embodiment it is the sensor 1) detects a message with its ID, the sensor 1 responds by sending out a message 93 broadcasting an “ON” signal (the sensor ID) on the assigned UL communication resources. Sensors requiring more “data” UL resources also use the message 93 to request for more UL resources. In response to the message 93, the gNB 7 may send back to the sensor 1 on the assigned DL control resources a UL resource grant message 94. The message 94 also comprises update frequency details, the request ID, and the SM ID. In this embodiment, the SM ID is the SM 8 ID. After receiving the message 94, the sensor 1 sends an acknowledgement message 95 back to the gNB 7 acknowledging the assigned UL communication resources and updated frequency. The gNB 7 may propagate the acknowledgement message (assigned UL resources and update frequency ACK) to the E-SM 8-1. In the end of the initial setup, the gNB 7 communicates to the sensor 1 a synchronization message 96 with the update start point in time.

The sensor 1 waits until the beginning of each update instance and checks if the assigned UL resources are available by sending a broadcast message 97 indicating the sensor ID and request ID. If resources are available, the gNB 7 sends a resource grant message 98 on the assigned DL resources. Responsive to the receipt of message 98, the sensor 1 sends a message 99a with the requested update info and the SM ID. The message 99a is sent back to the gNB 7 on the assigned UL resources. The network node gNB 7 relays the update info together with the sensor ID towards the E-SM 8-1 in a message 99b. The E-SM 8-1 acknowledges the receipt of the message 99b with the update info and the sensor ID by sending back to the gNB 7 an acknowledgement message 99c. Upon receipt of the message 99c, the network node gNB 7 relays to the sensor 1 a message 99d acknowledging receipt of the update info by the E-SM 8-1. The message 99d contains the SM ID. Further, the E-SM 8-1 may send a sensor database update request message 99e to the SM-F 8-2. The message 99e may comprise the update info and the sensor ID.

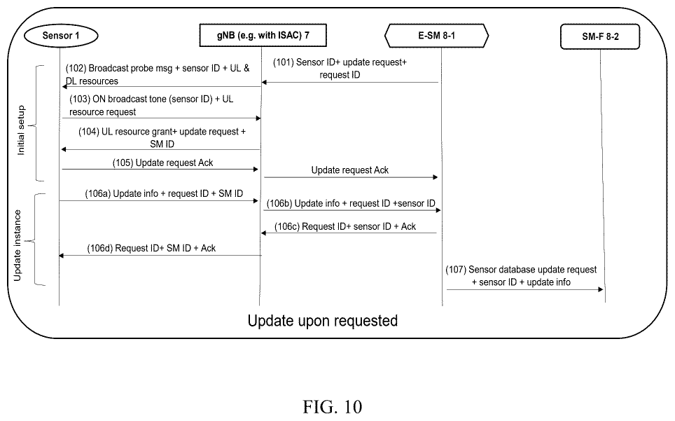

FIG. 10 illustrates an embodiment of sensor status flow updated upon a request with the sensing manager SM in the hierarchical form, provided by way of example and described below.

During the initial setup the E-SM 8-1 sends an update request message 101 to the gNB 7. The update request message 101 may contain a request ID and a sensor ID. In this embodiment the sensor selected by the E-SM 8-1 is the sensor 1. Accordingly, the sensor ID corresponds to the sensor 1. Responsive to the message 101, the gNB 7 may broadcast a probing message 102. The probing message 102 contains the sensor ID and indication of assigned UL & DL resources to be used for control and communication. The probing message 102 is broadcasted on a dedicated DCL channel (PDSCCH). Sensors monitor the PDSCCH periodically, and once a sensor detects a message with its ID (in this embodiment it is the sensor 1), the sensor 1 responds with a message 103 broadcasting an “ON” signal (the sensor ID). The message 103 is broadcasted on the assigned UCL control resources. Sensors requiring more “data” UL resources also use the message 103 to request more resources. The gNB 7 may respond to the message 103 by sending on the assigned DCL control resources a UL resource grant message 104. The message 104 may comprise the update request details, the request ID, and the SM ID. In this embodiment the SM ID corresponds to the SM 8. The sensor 1 acknowledges receipt of the message 104 by sending back to the gNB 7 a message 105 (update request ACK). The gNB 7 relays the update request ACK to the E-SM 8-1.

During the update instance phase, the sensor 1 sends a message 106a with the requested update information, the request ID and the SM ID. The message 106a is sent to the gNB 7 on the assigned UL resources. The network node gNB 7 relays the requested update information together with the request ID and the sensor ID in a message 106b to the E-SM 8-1. In response to the message 106b, the E-SM 8-1 sends back to the gNB 7 an acknowledging message 106c. The acknowledgement message 106c may contain the request ID and the sensor ID. Responsive to the message 106c, the gNB 7 relays the acknowledge of requested update info receipt in a message 106d to the sensor 1. The message 106d may contain the request ID and the SM ID. Further, the E-SM 8-1 may send a sensor database update request message 107 to the SM-F 8-2. The message 107 may comprise the update info and the sensor ID.

In some embodiments, the SM may configure one or more sensors to fulfill a sensing service request with an adequate (e.g. highest possible) quality of service. The configuration may involve messaging the sensors using configuration instructions, via the network node providing network access (e.g. the gNB). This sensor configuration may be performed during initial set up of the sensors to fulfill the sensing service request, for example as part of probe messages such as messages 47a and 87a. Configuring the sensors may include adjusting the operation, mode, location, orientation, or combination thereof, of each of one or more sensors. The configuration may be set so that a best possible, or at least an adequate, set of sensor measurements is obtained. Sensors may be repositioned, recalibrated, or otherwise adjusted to perform certain operations in response to such configuration instructions from the SM. The SM may determine the configuration instructions via computation such as optimization computation.

Accordingly, the SM may adjust or optimize the configuration, location, orientation, and/or angle of a sensor which is already registered with the SM. To support this, the SM may run one or more optimization functions, and communicate the results in the form of control message carried by the network node towards the sensors (already registered in the sensor database) that are to be used to fulfill the sensing service request. The sensors may then perform operations to fulfill the instructions in the control messages and subsequently begin the process of fulfilling the sensing request as described elsewhere herein.

In some embodiments, the SM may adjust (e.g. optimize) the sensing capability of a network node providing network access, for example by adjusting the sensors as described above. Additionally or alternatively, the SM may adjust (e.g. optimize) the sensing capability of a network node by causing additional sensors to be registered for association or attachment to the network node. These additional sensors can be owned by one or more sensor providers, such as a network operator or one or more third parties.

In some embodiments, the SM may consult its sensor database and determine a need for certain additional sensors (e.g. additional types of sensors, additional quantities of sensors, or both) either in general or as required to fulfill a sensing service request. Upon determining the need for additional sensors, the SM may send a request, including the details of the required additional sensors, to one or more sensor providers, such as a network operator, a third party, or another one or more entities. The request may be transmitted to a recipient via the network node providing network access (e.g. gNB) or via another route. Upon the receipt of the request by the sensor supplier, if the requested sensor(s) can be supplied within a limited time frame for fulfilling the sensing service request, the sensor(s) may be deployed and used to fulfill the sensing service request. The deployed sensors may undergo a registration process with the SMF once they enter the vicinity of the network node and the SMF may accordingly add the sensors to the database and subsequently instruct their operation. The sensing process then continues as described elsewhere herein.

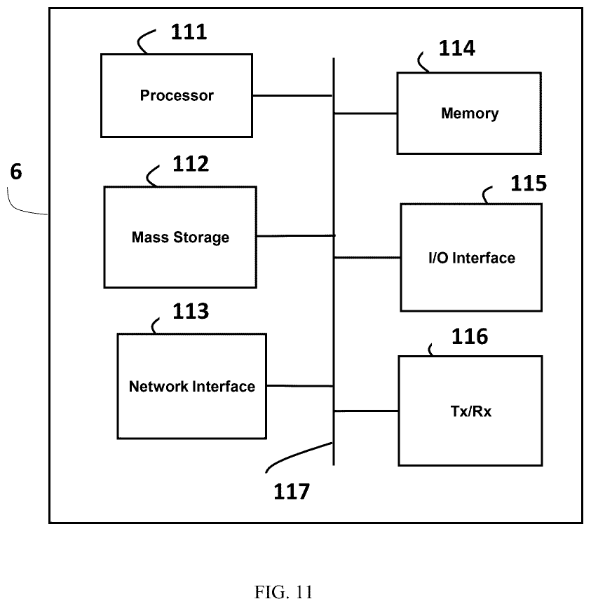

FIG. 11 is a block diagram of an electronic device 6 which was denoted in the present disclosure as a user equipment UE (or a sensing consumer, or a mobile device). For example, a computer equipped with network function may be configured as electronic device 6. The electronic device 6 may correspond to parts of a sensing consumer (UE), network node providing network access (e.g. gNB), or a network node providing part or all of a sensing manager function.

As shown, the device 6 includes a processor 111, such as a Central Processing Unit (CPU) or specialized processors such as a Graphics Processing Unit (GPU) or other such processor unit, memory 140, non-transitory mass storage 112, I/O interface 115, network interface 113, and a transceiver 116, all of which are communicatively coupled via bi-directional bus 117. According to certain embodiments, any or all of the depicted elements may be utilized, or only a subset of the elements. Further, the device 6 may contain multiple instances of certain elements, such as multiple processors, memories, or transceivers. Also, elements of the hardware device may be directly coupled to other elements without the bi-directional bus. Additionally or alternatively to a processor and memory, other electronics, such as integrated circuits, may be employed for performing the required logical operations.

The memory 114 may include any type of non-transitory memory such as static random access memory (SRAM), dynamic random access memory (DRAM), synchronous DRAM (SDRAM), read-only memory (ROM), any combination of such, or the like. The mass storage element 112 may include any type of non-transitory storage device, such as a solid state drive, hard disk drive, a magnetic disk drive, an optical disk drive, USB drive, or any computer program product configured to store data and machine executable program code. According to certain embodiments, the memory 114 or mass storage 112 may have recorded thereon statements and instructions executable by the processor 111 for performing any of the aforementioned method operations described above.

It is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations, or equivalents that fall within the scope of the present invention.

1. A method comprising, by a network node providing network access:
receiving a message on a predetermined wireless communication channel which conveys messages for both a networked sensing service and a networked communication service wherein the message indicates a request of the networked sensing service; and
coordinating with a sensing manager function to fulfill the request of the networked sensing service, using sensors registered with the sensing manager function.

2. The method of claim 1, wherein said coordinating with the sensor manager function is performed upon detecting that the message indicates the request of the networked sensing service at least in part by differentiating the message from a message indicative of a communication service request, wherein the message contains at least one predetermined bit set to a predetermined value to indicate the request of the networked sensing service.

3. The method of claim 1, wherein the sensing manager function comprises a first entity co-located with the network node or located elsewhere at an edge of a communication and sensing network, and a second entity located in a core of the communication and sensing network or elsewhere away from the edge of the communication and sensing network.

4. The method of claim 1, further comprising, requesting and receiving details of the request of the networked sensing service, the details of the request of the networked sensing service including one or both of: a location to be subjected to sensing; and sensing-related information required to fulfill the request of the networked sensing service, wherein the requesting details of the request of the networked sensing service comprises:
indicating communication resources; and
the receiving details of the request of the networked sensing service comprises:
receiving the details via the communication resources.

5. The method of claim 1, wherein said coordinating with the sensing manager function comprises:
sending details of the request of the networked sensing service to the sensing manager function, the details of the request of the networked sensing service including one or both of: a location to be subjected to sensing; and sensing-related information required to fulfill the request of the networked sensing service;
receiving, from the sensing manager function, a first indication of one or more sensors to utilize in fulfilling the request of the networked sensing service, and a second indication of sensed data required from each of the one or more sensors; and
interacting with the one or more sensors according to the first indication and the second indication to obtain the sensed data required from each of the one or more sensors.

6. The method of claim 5, wherein interacting with the one or more sensors comprises indicating, to each of the one or more sensors, communication resources allocated for use by the one or more sensors in providing the sensed data to the network node, and receiving, via the communication resources allocated for use by the one or more sensors, data usable in fulfilling the request of the networked sensing service.

7. The method of claim 5, further comprising, after receiving the first indication from the sensing manager function, indicating, to an initiator of the request of the networked sensing service or a related device, communication resources, wherein the network node transmits the sensed data to the initiator or the related device, in association with the sensing request, using the communication resources.

8. The method of claim 1, further comprising:
receiving sensed data usable in fulfilling the request of the networked sensing service;
communicating with the sensing manager function to verify that the received sensed data fulfills the request of the networked sensing service; and
providing the sensed data to an initiator of the request of the networked sensing service or a related device upon said verifying that the received sensed data fulfills the request of the networked sensing service.

9. The method of claim 1, further comprising, upon determining that the request of the networked sensing service has been fulfilled, communicating a utility report, to an AMF or another network function, that the request of the networked sensing service has been fulfilled, the utility report usable in charging for fulfilling the request of the networked sensing service, wherein the utility report includes an indication of an amount of resources consumed in fulfilling the request of the networked sensing service.

10. The method of claim 1, further comprising:
interacting with the sensing manager function to register the one or more sensors with the sensing manager function; and
interacting with one or more sensors to initialize and maintain one or more of:
registration of the one or more sensors, including locations and capabilities thereof, in a database accessible to the sensing manager function;
configuration of the one or more sensors to fulfill the sensing service request with an adequate quality of service; and
communication resources usable for communication between the network node and the one or more sensors.

11. The method of claim 10, wherein said interacting with the sensing manager function comprises:
receiving, from the sensing manager function, an indication to update status of at least one of the one or more sensors at a specified update frequency; and
reporting status of the at least one of the one or more sensors to the sensing manager function at the specified update frequency, or
receiving, from the sensing manager, a request to update status of at least one of the one or more sensors; and
reporting status of the sensor the at least one of the one or more sensors to the sensing manager in response to the request.

12. The method of claim 11, wherein said reported status comprises one or more of: sensor responsiveness, sensor capabilities, and sensor location.

13. The method of claim 1, further comprising interacting with the sensing manager function to:
receive a configuration instruction for configuring one of more of the sensors to fulfill the sensing service request, and forward the instruction to said one or more of the sensors; or
receive a request for one or more additional sensors to be registered with the sensing manager function, and forward the request for one or more additional sensors to one or more sensor providers.

14. A method comprising, by a mobile device accessing a network:
sending, to a network node providing access to the network: a message on a predetermined wireless communication channel which is used to support both a networked sensing service and a networked communication service, the message configured to be indicative of a request of the networked sensing service.

15. The method of claim 14, wherein message contains at least one predetermined bit set to a predetermined value to indicate the request of the networked sensing service.

16. The method of claim 14, further comprising:
receiving a request for details of the request of the networked sensing service, the details of the request of the networked sensing service including one or both of: a location to be subjected to sensing; and sensing-related information required to fulfill the request of the networked sensing service; and
sending, to the network node, the details of the request of the networked sensing service.

17. The method of claim 16, further comprising receiving, along with the request for details of the request of the networked sensing service, an indication of communication resources allocated for use in further communications with the network node regarding the request of the networked sensing service, wherein the details of the request of the networked sensing service are sent via the communication resources.

18. A network node providing network access and configured to:
receive a message on a predetermined wireless communication channel which conveys messages for both a networked sensing service and a networked communication service wherein the message indicates a request of the networked sensing service; and
coordinate with a sensing manager function to fulfill the request of the networked sensing service, using sensors registered with the sensing manager function.

19. The network node of claim 18, wherein said coordinating with the sensor manager function is performed upon detecting that the message indicates the request of the networked sensing service at least in part by differentiating the message from a message indicative of a communication service request.

20. The network node of claim 18, wherein the sensing manager function comprises a first entity co-located with the network node or located elsewhere at an edge of a communication and sensing network, and a second entity located in a core of the communication and sensing network or elsewhere away from the edge of the communication and sensing network.
